(19) United States
(12) Patent Application Publication
(10) Pub. No.: US 2016/0358086 A1
(43) Pub. Date: Dec. 8, 2016

(54) TOPICAL DIGITAL CHATTER ANALYSIS VIA AUDIENCE SEGMENTATION

(71) Applicant: Facebook, Inc., Menlo Park, CA (US)

(72) Inventors: Jason Sundram, San Francisco, CA (US); Neil A. Kodner, Saratoga, CA (US); Mui Thu Tran, San Carlos, CA (US); Guangdeng Liao, San Jose, CA (US); Justin Thomas Palumbo, Menlo Park, CA (US); Guven Burc Arpat, Los Altos, CA (US); Amit Bahl, Pleasanton, CA (US)

(21) Appl. No.: 14/732,534

(22) Filed: Jun. 5, 2015

(51) Int. Cl. G06N 5/04; H04L 29/08

(52) U.S. Cl. CPC G06N 5/048; H04L 67/22

(57) ABSTRACT

Some embodiments include a method of performing a content analysis study around a central theme utilizing a concept study system. The concept study system can generate a classifier machine corresponding to the content analysis study based on a super topic taxonomy including one or more concept identifiers. The concept study system can process a content object, associated with a user activity in a social networking system, through the classifier machine to determine whether to assign the user activity to the content analysis study. The concept study system can aggregate at least an attribute derived from the user activity in a study-specific data container associated with the content analysis study and compute a statistical or analytical insight based on aggregated attributes in the study-specific data container.

### BACKGROUND

Machine intelligence may be useful to gain insights to a large quantity of data that is undecipherable to human comprehension. Machine intelligence, also known as artificial intelligence, can encompass machine learning analysis, natural language parsing and processing, computational perception, or any combination thereof. These technical means can facilitate studies and researches yielding specialized insights that are normally not attainable by human mental exercises.

For example, various natural language processing and analyses can be performed on activities available in or to a social networking system to generate insights associated with human interactions. Such natural language processing and analyses consume large amount of computational resources. When the amount of data that is analyzed increases, real-time or near real-time insights become challenging to produce. Yet the more data that is analyzed, the clearer the generated insights would be. A preset filter may be used to reduce input user data provided to the machine intelligence and thus decrease the amount of data to analyze. However, the preset filter can easily become outdated and may not be sophisticated enough to capture all relevant activities that may affect decisions of the machine intelligence.

### BRIEF DESCRIPTION OF THE DRAWINGS

FIG. 1 is a block diagram illustrating an application service system implementing a concept study system, in accordance with various embodiments.

FIG. 2 is a block diagram illustrating a chatter tracker engine, in accordance with various embodiments.

FIG. 3 is an example screenshot of a super topic creation interface for defining a super topic taxonomy, in accordance with various embodiments.

FIG. 4 is an example illustration of a chatter insight interface, in accordance with various embodiments.

FIG. 5A is an example illustration of a gender demographic table in the audience segmentation panel of the chatter insight interface of FIG. 4, in accordance with various embodiments.

FIG. 5B is an example illustration of an age demographic table in the audience segmentation panel of the chatter insight interface of FIG. 4, in accordance with various embodiments.

FIG. 5C is an example illustration of an education level demographic table in the audience segmentation panel of the chatter insight interface of FIG. 4, in accordance with various embodiments.

FIG. 5D is an example illustration of a relationship status demographic table in the audience segmentation panel of the chatter insight interface of FIG. 4, in accordance with various embodiments.

FIG. 5E is an example illustration of a hashtag list in a top items panel of the chatter insight interface of FIG. 4, in accordance with various embodiments.

FIG. 5F is an example illustration of a topic list in a top items panel of the chatter insight interface of FIG. 4, in accordance with various embodiments.

FIG. 5G is an example illustration of an element list in a top items panel of the chatter insight interface of FIG. 4, in accordance with various embodiments.

FIG. 5H is an example illustration of a country list in a top items panel of the chatter insight interface of FIG. 4, in accordance with various embodiments.

FIG. 5I is an example illustration of a region list in a top items panel of the chatter insight interface of FIG. 4, in accordance with various embodiments.

FIG. 6A is an example illustration of a content engagement activity that qualifies as being relevant to a content analysis study according to a super topic taxonomy, in accordance with various embodiments.

FIG. 6B is an example illustration of a content generation user activity that qualifies as being relevant to a content analysis study according to a super topic taxonomy, in accordance with various embodiments.

FIG. 7 is a flow chart illustrating a method of operating a concept study system, in accordance with various embodiments.

FIG. 8 is a flow chart illustrating a method of operating a chatter tracker engine, in accordance with various embodiments.

FIG. 9 is a high-level block diagram of a system environment suitable for a social networking system, in accordance with various embodiments.

FIG. 10 is a block diagram of an example of a computing device, which may represent one or more computing device or server described herein, in accordance with various embodiments.

FIG. 11 is an example of a data row diagram associated with a user-generated content object, in accordance with various embodiments.

The figures show various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

Several embodiments are directed to a concept study system. The concept study system can be used to provide insights and generate studies of user “chatter” (e.g., user posts and/or comments) in an application service system or a social networking system. The concept study system can implement various concept studies (e.g., content analysis studies) that analyze content related to user activities (e.g., content engagement activities and/or content generation activities). The concept study system can utilize a super topic taxonomy that defines a central theme amongst content that is to be monitored and analyzed in a concept study. A super topic system can facilitate creation of the super topic taxonomy by recording or recommending concept identifiers that may be associated within the central theme.

Based on the set of concept identifiers, the concept study system can create one or more classifier machines as content filters that determine whether or not a content object associated with a user activity is relevant to the concept study according to the super topic taxonomy. A classifier machine can be a computational model that processes at least a content object and produces a categorization of the content object. The classifier machine can be implemented as a computational engine, program, or module.

For example, the classifier machines can include deterministic finite automatons, finite state machines, tree automatons, Boolean machines, pattern/string matching algorithms (e.g., Aho-Corosick matching), regular expression string matching, contrast motif finders (CMF), decision trees/tries, random forest classifier models, Bayesian classifier models, ensemble classifier models, other classifier models, or any combination thereof. In some embodiments, the classifier machines include the Boolean machines, finite state machines, deterministic finite automatons, and/or string matching algorithms because they enable the classifier machines to process content object associated with the user activities in real time as the user activities are received. These machines can accomplish this because they do not require supervised training and are not as resource intensive as regular expression string matching. In some embodiments, regular expression string matching is preferred because of its support for backtracking. In some embodiments, various classifier models that require supervised training or preferred because of their ability to expand the potential to capture additional relevant content that is otherwise not available by finite automatons.

In several embodiments, a classifier machine includes a Boolean expression, a regular expression, a decision tree, a dictionary, or any combination thereof, derived from the super topic taxonomy. For example, a Boolean tag can be associated with one or more of the concept identifiers. In an example, a logical “NOT” can be associated with a concept identifier to denote that the super topic taxonomy includes the lack of the concept identifier instead of the inclusion of the concept identifier. In another example, a logical “OR” can be associated with two concept identifiers to denote that the super topic taxonomy requires only one of the concept identifiers to be present when performing content analysis by the classifier machines. In yet another example, a logical “AND” can be associated with two concept identifiers to denote that the super topic taxonomy requires both of the concept identifiers to be present when performing content analysis by the classifier machines.

In one example, a classifier machine can take a serialized data row representing a content object corresponding to a user activity as its input. The classifier machine can determine which, if any, of the monitored super topic taxonomies corresponding to one or more concept studies that the content object belongs to. This determination can produce an assignment of the content object, the user activity, and/or an acting user of the user activity to a study-specific data storage.

In some embodiments, the classifier machine places a user (e.g., an acting user or a participating user) associated with the user activity into an audience segmentation associated with the assigned concept study and the super topic taxonomy associated therewith. The audience segmentation can enable live monitoring of users that are interested in a particular concept topic associated with a concept study. The audience segmentation can be updated in real-time or in batch mode. The audience segmentation can be fed into a targeting engine to present, in real-time or asynchronously, content (e.g., advertisement or content suggestions) to target users interested in the super topic monitored by the concept study system. A chatter tracker engine can aggregate and compile demographics, statistics, and/or attributes of the audience segmentation. A concept analysis engine can analyze the aggregated data to produce statistical or analytical insights (e.g., in the form of text, comparison table, visualization, or any combination thereof). A statistical or analytical insight can be a computer-rendered illustration or a computational measurement from processing the aggregated data. For example, the concept analysis engine can compare a statistical measure of at least a portion of the aggregated data against a baseline standard (e.g., data pertaining to all users, user activities, and/or content objects in the application service system or the social networking system).

The concept study system enables labeling of a stream of user-generated content according to topical interests of the concept study system in real time. This then enables the concept study system to aggregate and compile user demographics relevant to a topical interest in real-time. The aggregated user demographics can be fed into a content targeting engine (e.g., for advertisement or personalized data presentation).

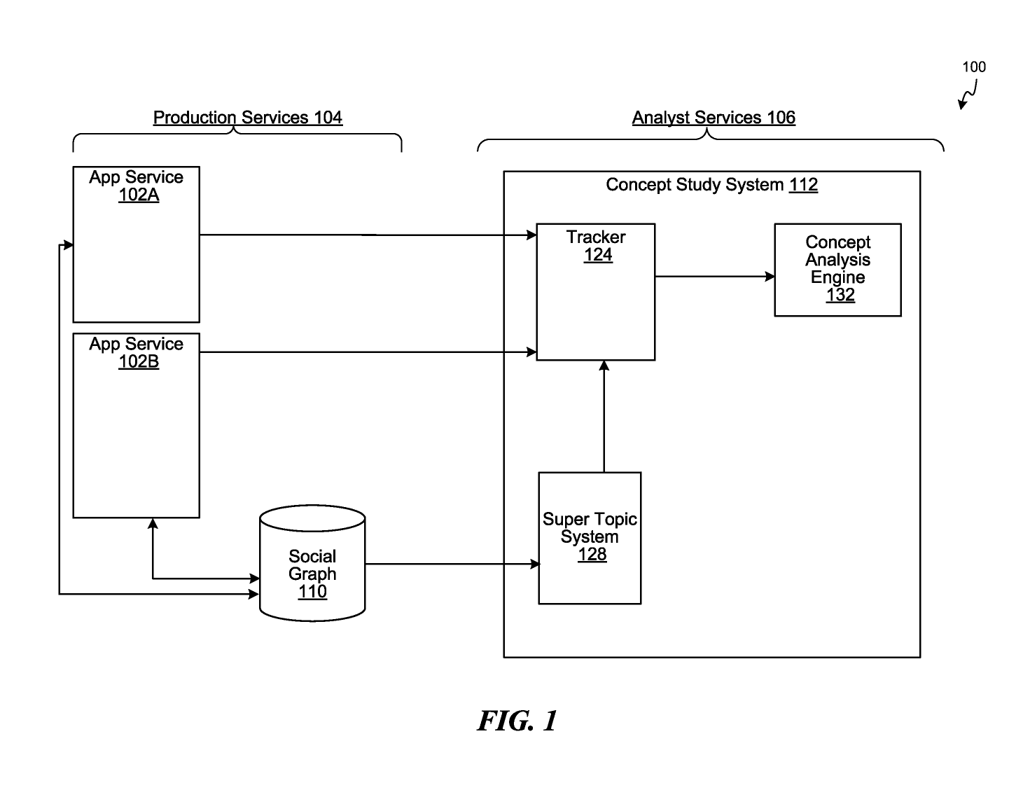

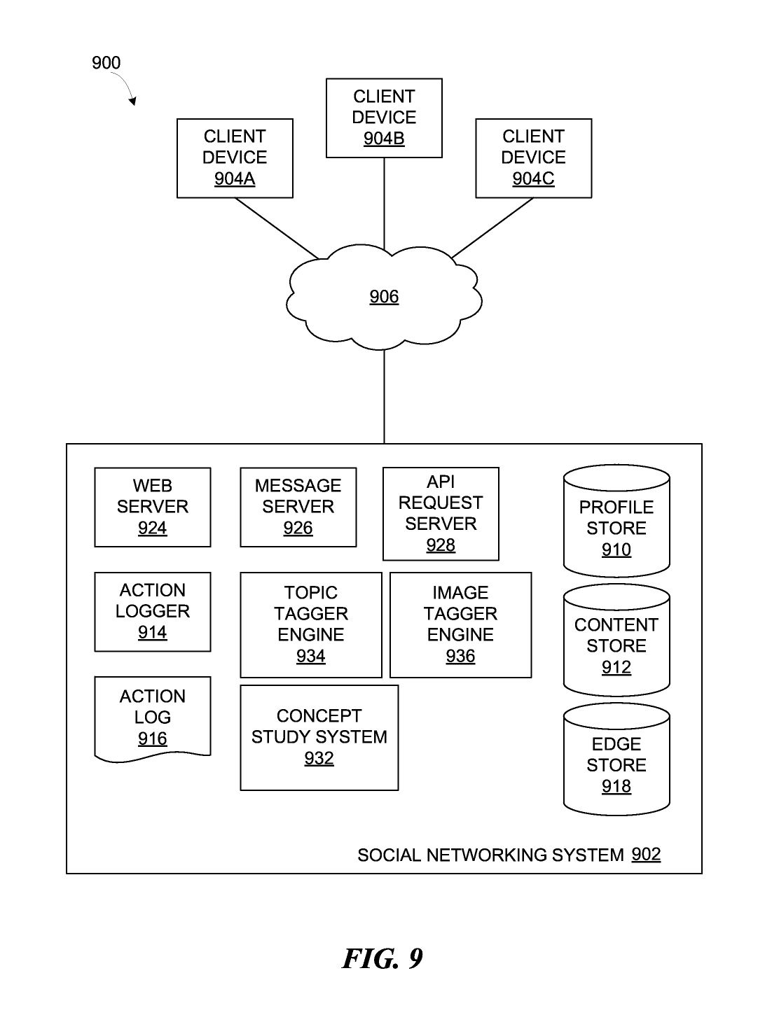

Referring now to the figures, FIG. 1 is a block diagram illustrating an application service system 100 implementing a concept study system 112, in accordance with various embodiments. The application service system 100 provides one or more application services (e.g., an application service 102A and an application service 102B, collectively as the “application services 102”) to client devices over one or more networks (e.g., a local area network and/or a wide area network). The application service system 100 can provide the application services 102 via an application programming interface (API), a Web server, a mobile service server (e.g., a server that communicates with client applications running on mobile devices), or any combination thereof. In some embodiments, the application service system 100 can be a social networking system (e.g., the social networking system 902 of FIG. 9). The application services 102 can process client requests in real-time. The client requests can be considered “live traffic.” For example, the application services 102 can include a discussion forum service, a photo sharing tool, a location-based tool, an advertisement platform, a media service, an interactive content service, a messaging service, a social networking service, or any combination thereof.

The application service system 100 can include one or more production services 104 that are exposed to the client devices, directly or indirectly, and include one or more analyst services 106. In some embodiments, the analyst services 106 are not exposed to the client devices. In some embodiments, the analyst services 106 can be exposed to a limited subset of the client devices. In some cases, the analyst services 106 can be used by operators of the application service system 100 to gain insights based on activities of the production services 104 (e.g., in real-time or asynchronously relative to the activities). In some cases, the analyst services 106 can be used to monitor, maintain, or improve the application services 102. In one example, at least one of the production services 104 can directly communicate with the client devices and respond to client requests from the client devices. In another example, a first outfacing production service can indirectly provide its service to the client devices by servicing a second outfacing production service. The second outfacing production service, in turn, can either directly provide its service to the client devices or provide its service to a third outfacing production service that directly provides its service to the client devices. That is, the production services 104 may be chained when providing their services to the client devices.

The application service system 100 includes the concept study system 112. The concept study system 112 can be one of the analyst services 106. The concept study system 112 can monitor and analyze user activities with the application services 102 to generate insights. For example, a concept analysis engine 132 can generate the insights. The insights can be generated in real-time, substantially real-time, or asynchronously relative to the user activities.

For example, real-time user activities (e.g., user-initiated services requests and responses) can be forwarded to the concept study system 112 for processing. For example, real-time user activities can be tracked by the action logger 914 of FIG. 9. Past user activities can be tracked in a social graph 110. For example, the social graph 110 can be stored in the edge store 918 of FIG. 9.

The real-time user activities can be forwarded to a tracker engine 124. The tracker engine 124 can determine whether or not a particular user activity pertains to a “concept study.” A concept study is a content analysis study pertaining to a conceptual topic. The concept study provides a way to utilize machine intelligence to compute insights pertaining to user activities related to a central theme (e.g., a common concept) by analyzing user-generated content generated in the application service system 100. The concept study system 112 can utilize one or more classifier machines to determine whether a user activity relates to a central theme. In some embodiments, each classifier machine corresponds to a single concept study. A classifier machine can be generated based on a super topic taxonomy. In some embodiments, a classifier machine is built solely on the super topic taxonomy without additional training data. In some embodiments, a classifier machine is built via machine learning (e.g., by utilizing training data of correctly labeled content).

In some embodiments, a single concept study can have multiple super topic taxonomies. In some embodiments, a single concept study can have only a single super topic taxonomy. These super topic taxonomies can be defined by a super topic system 128. The super topic system 128 can record and/or recommend one or more concept identifiers as part of a super topic taxonomy. A super topic taxonomy can used by the concept study system 112 to identify a subset of activities within the application service system 100 (e.g., a social networking system) for analysis (e.g., real-time or delayed analysis).

In several embodiments, the user activities being tracked by the tracker engine 124 can come from the application service system 100 and/or a computer system external to the application service system 100. In several embodiments, the past user activities used by the super topic system 128 to suggest concept recommendations can come from the application service system 100 and/or a computer system external to the application service system 100.

A user interface of the super topic system can construct a super topic taxonomy by identifying one or more concept identifiers to associate with the super topic taxonomy. An analyst user can seed the super topic taxonomy with one or more explicit concept identifiers. Concept identifiers are ways of identifying content (e.g., user-generated digital chatter) as being related to a central theme.

Concept identifiers used to build a super topic taxonomy can include, for example, topic tags, hashtags, and/or terms. A topic tag, for example, can be represented as a social network page. A hashtag is a word that may be found within user-generated content denoting an authoring user's own intention for the content to be part of a topic. A hashtag can have a known prefix or suffix (e.g., typically a prefix of the pound symbol “#”). A hashtag can be represented as a social network object. A term can be a text string comprised of two or more consecutive words.

User-generated content can be associated with a topic tag based on a topic inference engine or based on user indication (e.g., an explicit mention in a post or a status update. A topic tag can be a social network object that references a social network page. The topic tag can be associated with a portion of content in one or more ways. In one example, a social networking system can implement a topic inference module that infers topics based on content items in user-generated content. For example, U.S. patent application Ser. No. 13/589,693, entitled “Providing Content Using Inferred Topics Extracted from Communications in a Social Networking System” discloses a way to infer interests based on extracted topics from content items on a social networking system. In another example, an authoring user of a piece of content can associate the topic tag with the piece of content that it creates. For example, this can occur by an explicit reference to a social networking page in a user post (e.g., a social network “mention”) or an explicit reference in a status update or minutia. In some cases, a user visiting the social network object can make the topic tag.

A hash tag is an example of a concept identifier that associates with content based on the authoring user of the content. A hashtag is a word or phrase preceded by a hash or pound sign (“#”) to identify messages relating to a specific topic. The authoring user can insert the hashtag in a piece of content he or she generates. For example, a hashtag can appear in any user-generated content of social media platforms, such as the social networking system 902 of FIG. 9.

A term object is a set of words (e.g., bigrams, trigrams, etc.) that may be tracked by the social networking system. In some embodiments, while the topic tag is associated with a social network page in a social graph of the social networking system, a term object is not part of the social graph. In these embodiments, once a term object is explicitly defined, the tracker engine 124 can track the term objects in content objects provided from the application services 102 and the social graph 110.

In some cases, a concept identifier may be associated with other concept identifiers according to a grouping of known similar concepts in the application service system 100. For example, a social networking system can implement a system to cluster social network pages having the same or substantially similar title or description and select one of the social network pages and its associated topic tag as the canonical topic tag associated with the title or description. A concept identifier that references a canonical topic tag can reference multiple social network pages within the cluster corresponding to the canonical topic tag. For example, U.S. patent application Ser. No. 13/295,000, entitled “Determining a Community Page for a Concept in a Social Networking System” discloses a way for equivalent concepts expressed across multiple domains to be matched and associated with a metapage generated by a social networking system.

In some embodiments, one or more objects (e.g., user-generated content objects) in the application service system 100 (e.g., the application service system 100 or the social networking system 902 of FIG. 9) may be associated with a privacy setting. The privacy settings (or “access settings”) for an object may be stored in any suitable manner, for example, in association with the object, in an index on an authorization server, in another suitable manner, or any combination thereof. A privacy setting of an object may specify how the object (or particular information associated with an object) can be accessed (e.g., viewed or shared) using the social networking system. Where the privacy settings for an object allow a particular user to access that object, the object may be described as being “visible” with respect to that user.

For example, a user of the social networking system may specify privacy settings for a user-profile page that identify a set of users that may access the work experience information on the user-profile page, thus excluding other users from accessing the information. In some embodiments, the privacy settings may specify a “blocked list” of users that should not be allowed to access certain information associated with the object. In other words, the blocked list may specify one or more users or entities (e.g., groups, companies, application services, etc.) for which an object is not visible. For example, a user may specify a set of users that may not access photos albums associated with the user, thus excluding those users from accessing the photo albums (while also possibly allowing certain users not within the set of users to access the photo albums).

In some embodiments, privacy settings may be associated with particular social-graph elements. Privacy settings of a social-graph element, such as a node or an edge, may specify how the social-graph element, information associated with the social-graph element, or content objects associated with the social-graph element can be accessed using the social networking system. For example, a social network object corresponding to a particular photo may have a privacy setting specifying that the photo may only be accessed by users tagged in the photo and their friends. In some embodiments, privacy settings may allow users to opt in or opt out of having their actions logged by social networking system or shared with other systems (e.g., internal or external to the social networking system). In some embodiments, the privacy settings associated with an object may specify any suitable granularity of permitted access or denial of access. For example, access or denial of access may be specified for particular users (e.g., only me, my roommates, and my boss), entities, applications services, groups of entities, users or entities within a particular degrees-of-separation (e.g., friends, or friends-of-friends), user groups (e.g., the gaming club, my family), user networks (e.g., employees of particular employers, students or alumni of particular university), all users (“public”), no users (“private”), users of external systems, particular applications (e.g., third-party applications, external websites, etc.), other suitable users or entities, or any combination thereof. Although this disclosure describes using particular privacy settings in a particular manner, this disclosure contemplates using any suitable privacy settings in any suitable manner.

In some embodiments, one or more servers may be authorization/privacy servers for enforcing privacy settings. In response to a request from a user or an entity for a particular object stored in a data store of the social networking system, the social networking system may send a request to the data store for the object. The request may identify the user or entity associated with the request and may only fulfill the request if the authorization server determines that the user is authorized to access the object based on the privacy settings associated with the object. If the requesting user is not authorized to access the object, the authorization server may prevent the requested object from being retrieved, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Social Networking System Overview

Several embodiments of the application service system 100 utilize or are part of a social networking system. Social networking systems commonly provide mechanisms enabling users to interact with objects and other users both within and external to the context of the social networking system. A social networking system user may be an individual or any other entity, e.g., a business or other non-person entity. The social networking system may utilize a web-based interface or a mobile interface comprising a series of inter-connected pages displaying and enabling users to interact with social networking system objects and information. For example, a social networking system may display a page for each social networking system user comprising objects and information entered by or related to the social networking system user (e.g., the user's “profile”).

Social networking systems may also have pages containing pictures or videos, dedicated to concepts, dedicated to users with similar interests (“groups”), or containing communications or social networking system activity to, from or by other users. Social networking system pages may contain links to other social networking system pages, and may include additional capabilities, e.g., search, real-time communication, content-item uploading, purchasing, advertising, and any other web-based inference engine or ability. It should be noted that a social networking system interface may be accessible from a web browser or a non-web browser application, e.g., a dedicated social networking system application executing on a mobile computing device or other computing device. Accordingly, “page” as used herein may be a web page, an application interface or display, a widget displayed over a web page or application, a box or other graphical interface, an overlay window on another page (whether within or outside the context of a social networking system), or a web page external to the social networking system with a social networking system plug in or integration capabilities.

As discussed above, a social graph can include a set of nodes (representing social networking system objects, also known as social objects) interconnected by edges (representing interactions, activity, or relatedness). A social networking system object may be a social networking system user, nonperson entity, content item, group, social networking system page, location, application, subject, concept or other social networking system object, e.g., a movie, a band, or a book. Content items can include anything that a social networking system user or other object may create, upload, edit, or interact with, e.g., messages, queued messages (e.g., email), text and SMS (short message service) messages, comment messages, messages sent using any other suitable messaging technique, an HTTP link, HTML files, images, videos, audio clips, documents, document edits, calendar entries or events, and other computer-related files. Subjects and concepts, in the context of a social graph, comprise nodes that represent any person, place, thing, or idea.

A social networking system may enable a user to enter and display information related to the user's interests, education and work experience, contact information, demographic information, and other biographical information in the user's profile page. Each school, employer, interest (for example, music, books, movies, television shows, games, political views, philosophy, religion, groups, or fan pages), geographical location, network, or any other information contained in a profile page may be represented by a node in the social graph. A social networking system may enable a user to upload or create pictures, videos, documents, songs, or other content items, and may enable a user to create and schedule events. Content items and events may be represented by nodes in the social graph.

A social networking system may provide various means to interact with nonperson objects within the social networking system. For example, a user may form or join groups, or become a fan of a fan page within the social networking system. In addition, a user may create, download, view, upload, link to, tag, edit, or play a social networking system object. A user may interact with social networking system objects outside of the context of the social networking system. For example, an article on a news web site might have a “like” button that users can click. In each of these instances, the interaction between the user and the object may be represented by an edge in the social graph connecting the node of the user to the node of the object. A user may use location detection functionality (such as a GPS receiver on a mobile device) to “check in” to a particular location, and an edge may connect the user's node with the location's node in the social graph.

A social networking system may provide a variety of communication channels to users. For example, a social networking system may enable a user to email, instant message, or text/SMS message, one or more other users; may enable a user to post a message to the user's wall or profile or another user's wall or profile; may enable a user to post a message to a group or a fan page; or may enable a user to comment on an image, wall post or other content item created or uploaded by the user or another user. In least one embodiment, a user posts a status message to the user's profile indicating a current event, state of mind, thought, feeling, activity, or any other present-time relevant communication. A social networking system may enable users to communicate both within and external to the social networking system. For example, a first user may send a second user a message within the social networking system, an email through the social networking system, an email external to but originating from the social networking system, an instant message within the social networking system, and an instant message external to but originating from the social networking system. Further, a first user may comment on the profile page of a second user, or may comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection is a social network edge. Being friends in a social networking system may allow users access to more information about each other than would otherwise be available to unconnected users. For example, being friends may allow a user to view another user's profile, to see another user's friends, or to view pictures of another user. Likewise, becoming friends within a social networking system may allow a user greater access to communicate with another user, e.g., by email (internal and external to the social networking system), instant message, text message, phone, or any other communicative interface. Being friends may allow a user access to view, comment on, download, endorse or otherwise interact with another user's uploaded content items. Establishing connections, accessing user information, communicating, and interacting within the context of the social networking system may be represented by an edge between the nodes representing two social networking system users.

In addition to explicitly establishing a connection in the social networking system, users with common characteristics may be considered connected (such as a soft or implicit connection) for the purposes of determining social context for use in determining the topic of communications. In at least one embodiment, users who belong to a common network are considered connected. For example, users who attend a common school, work for a common company, or belong to a common social networking system group may be considered connected. In at least one embodiment, users with common biographical characteristics are considered connected. For example, the geographic region users were born in or live in, the age of users, the gender of users and the relationship status of users may be used to determine whether users are connected. In at least one embodiment, users with common interests are considered connected. For example, users' movie preferences, music preferences, political views, religious views, or any other interest may be used to determine whether users are connected. In at least one embodiment, users who have taken a common action within the social networking system are considered connected. For example, users who endorse or recommend a common object, who comment on a common content item, or who RSVP to a common event may be considered connected. A social networking system may utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

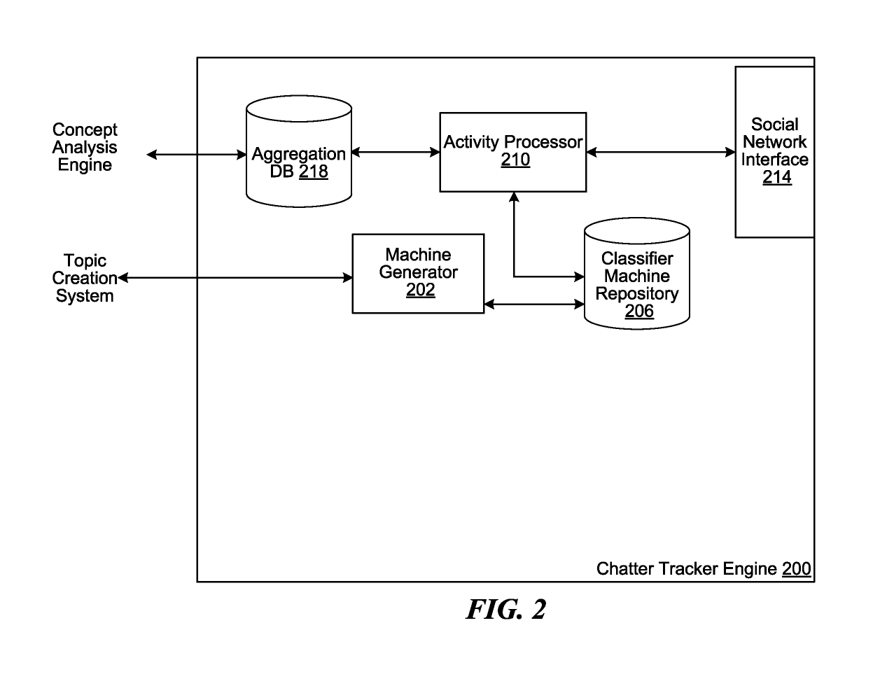

FIG. 2 is a block diagram illustrating a chatter tracker engine 200, in accordance with various embodiments. The chatter tracker engine 200 can be the tracker engine 124 of FIG. 1. The chatter tracker engine 200 includes a machine generator engine 202 coupled to a topic taxonomy generation system (e.g., the super topic system 128 of FIG. 1).

The machine generator engine 202 can produce classifier machines (e.g., string matchers, classifier models, decision trees, finite automaton machines, or any combination thereof) based on a super topic taxonomy that lists concept identifiers corresponding to a central theme. For example, the finite automaton machines can be finite state machines or Boolean machines. For example, the classifier models can be supervised learning models or unsupervised learning models. For example, the string matchers can be Aho-Corosick matching or regular expression string matching. In some embodiments, the classifier machines require training (e.g., supervise or unsupervised) to be built. In some embodiments, the classifier machines can be built directly from the super topic taxonomy without training/learning.

The concept identifiers can include an alphanumeric identifier string that identifies one or more social network objects in a social networking system (e.g., the social networking system 902 of FIG. 9) as belonging to a concept topic. The concept identifiers can include a term object represented by a text string of two or more consecutive words. The concept identifiers can include a text string representing a hashtag. The machine generator engine 202 can store the classifier machines in a classifier machine repository 206.

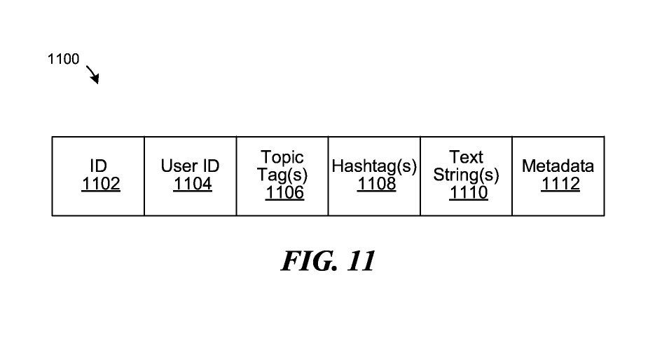

An activity processor engine 210 can be coupled to a social network interface 214. The social network interface 214 enables the activity processor engine 210 to access user activities occurring in the social networking system. In some embodiments, the social network interface 214 receives user activities in real time as they are first received by the social networking system. The social network interface 214 can extract a content object associated with a user activity that it receives. In one example, the user activity is a content engagement activity of an acting user engaging with the content object. In another example, the user activity is a content generation activity of an acting user creating the content object. For example, the content object can be represented as a data row as shown in FIG. 11.

The activity processor engine 210 can utilize one or more of classifier machines, each corresponding to a concept study, to filter the user activities. For example, the activity processor engine 210 can combine the classifier machines into an aggregate machine. The aggregate machine can analyze a text string in a content object associated with a user activity. The analysis can be a single pass or multiple passes analysis. The aggregate machine can assign each user activity and/or its corresponding content object to a particular concept study. In some embodiments, whenever a new concept study is created on the concept study system, or an existing concept study is modified, the chatter tracker engine 200 can re-build the aggregate machine.

In some embodiments, whenever a content object is assigned to a particular concept study, the activity processor engine 210 stores one or more identifiers of the content object, the user activity, and/or the acting user in the user activity in a study-specific data container assigned to the particular concept study. For example, identifiers of the acting users of the assigned user activities can form an audience segmentation corresponding to users that are interested in the central theme represented by a super topic taxonomy of the particular concept study. In some embodiments, whenever a content object is assigned to a particular concept study, the activity processor engine 210 stores one or more attributes of the content object, the user activity, and/or the acting user in a study-specific data container assigned to the particular concept study.

In some embodiments, the activity processor engine 210 can implement a noise identifier machine that evaluates whether a target user activity assigned to the concept study can be considered noise. For example, the noise identifier machine can be a statistical model that analyzes whether the target user activity is associated with an attribute that deviates significantly from other user activities assigned to the particular concept study. In some embodiments, the activity processor engine 210 can implement a polarity identifier machine that labels one of the target user activity as a positive affiliation to the concept study or negative affiliation to the concept study. For example, the polarity identifier machine can analyze a text string in a content object associated with the target user activity to identify positive or negative words to make the determination of its polarity label.

In several embodiments, the chatter tracker engine 200 can implement an aggregation database 218 storing one or more study-specific data containers corresponding to one or more concept studies. In some embodiments, a concept study can have an expiration date. If a concept study have an expiration date, then the study-specific data containers can be wiped or deleted upon expiration of the concept study. Likewise, a classifier machine corresponding to the concept study can also be expired, suspended, or deleted upon expiration of the concept study. In some embodiments, individual user activity that has been aggregated by the chatter tracker engine 200 can have an expiration date or expiration duration (e.g., 2 weeks from the user activity). For example, if the concept study relates to users who post of travel plans, each post may only be relevant for a set period of time before its user finishes his or her travels.

FIG. 11 is an example of a data row diagram associated with a user-generated content object 1100, in accordance with various embodiments. The user-generated content object 1100 can be passed to the activity processor engine 210 as a serialized string represented by this example data row diagram. The user-generated content object 1100 can include an object identifier 1102, a user identifier 1104, one or more topic tags 1106, one or more hashtags 1108, one or more text strings 1110, one or more metadata fields 1112, etc.

The object identifier 1102 may be a numeric or alphanumeric string that can uniquely identify a content object in a social networking system or an application service system (e.g., the application service system 100 of FIG. 1 or the social networking system 902 of FIG. 9). The user identifier 1104 may be a numeric or alphanumeric stream that can uniquely identify a user in the social networking system or the application service system. In some embodiments, the user identifier 1104 is the authoring user who created the user-generated content object 1100. In some embodiments, the user identifier 1104 is hashed such that an additional layer of security protects the privacy of the users.

In several embodiments, a content engagement activity can cause the user-generated content object 1100 to be processed by the activity processor engine 210. In some embodiments, the data row can label the user identifier 1104 in the data row as the acting user who engages with the target content object. In some embodiments, the user identifier 1104 remains as the identifier of the authoring user who created with the target content object. In some embodiments, the data row can include both the user identifier of the authoring user and the user identifier of the acting user.

The topic tags 1106 are concept identifiers represented as numeric or alphanumeric strings. For example, a topic tag can reference a social network page. A topic tag can be created by a topic tagger engine that analyzes text of the user-generated content object, an image tagger engine that analyzes images of the user-generated content object, the authoring user by explicitly mentioning the social network page in the user-generated content object, or any combination thereof. The hashtags 1108 are concept identifiers represented as one or more of text strings, numeric strings, or alphanumeric strings.

The text strings 1110 are the textual content of the user-generated content object 1100. For example, in a user-generated post, the text strings 1110 can include just the text of the post, just the comments to the post, or a combination thereof. A classifier machine can attempt to match concept identifiers specified in a super topic taxonomy to the topic tags 1106 and the hashtags 1108. The classifier machine can also attempt to match the concept identifiers in the super topic taxonomy in the text strings 1110. For example, a hashtag or an explicit mentioning of a topic tag can be found within the text strings 1110. A term object in the super topic taxonomy can comprise two or more consecutive words. In an example, the term object can be “romantic stories.” In this example, the classifier machine can attempt to match the string “romantic stories” within the text strings 1110. The metadata fields 1112 can contain attribute data to be aggregated by the activity processor engine 210. For example, the metadata fields 1112 can contain geolocation information, computer network address information, timestamp, other information, or any combination thereof, that are associated with the creation of, or engagement with, the user-generated content object 1100.

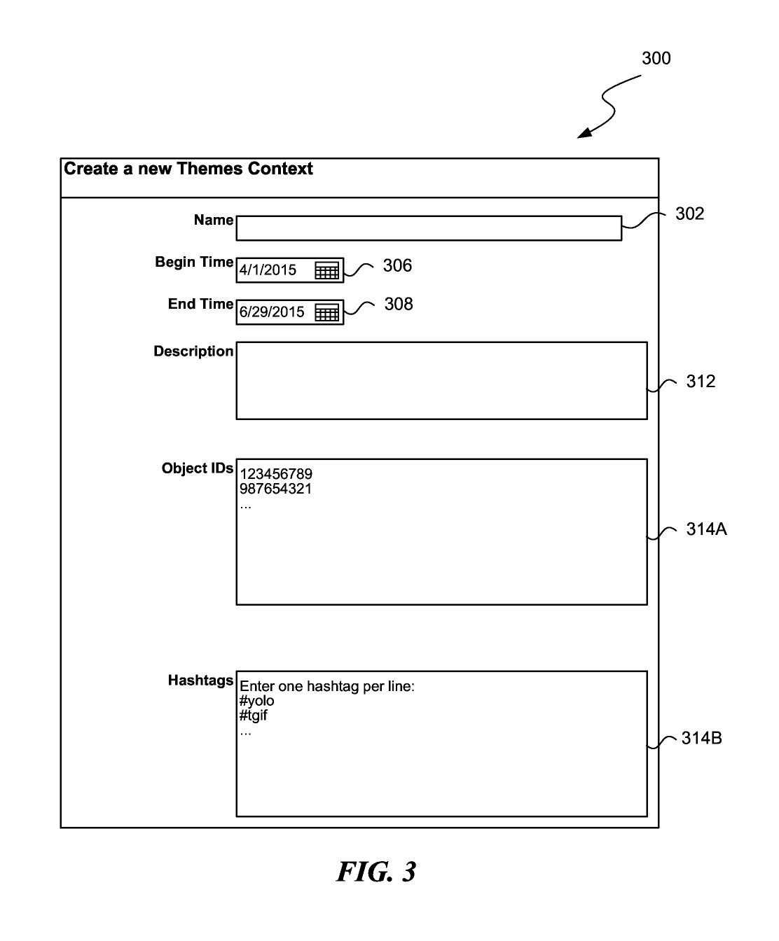

FIG. 3 is an example screenshot of a super topic creation interface 300 for defining a super topic taxonomy, in accordance with various embodiments. The super topic creation interface 300 can be implemented by the super topic system 128 of FIG. 1. The super topic creation interface 300 can include a name input element 302 for an analyst user to configure the name of a super topic taxonomy. The configured name can also reference one or more classifier machines generated based on the super topic taxonomy. The super topic creation interface 300 can include a begin time 306 and an end time 308 associated with a content analysis study or a portion thereof represented by the super topic taxonomy. The begin time 306 and the end time 308 can specify years, months, dates, hours, minutes, seconds, or any combination thereof. The begin time 306 and the end time 308 can create a time window that super topic taxonomy would be effective. In some embodiments, one or more classifier machines that implement filters based on the super topic taxonomy would begin to function at the begin time 306 and expire at the end time 308. The expiration of the classifier machines can occur automatically and says preventing wasting of computational resources when analyst users are no longer interested in content relating to the super topic taxonomy.

The super topic creation interface 300 can include a description input element 312 for an analyst user to denote a description text describing a central theme or concept that the analyst user is trying to monitor. In some embodiments, the description text is used to inform other analyst users of the nature of the super topic taxonomy and the concept study associated therewith. In some embodiments, the description text is used by a search mechanism of a concept study system (e.g., the concept study system 112 of FIG. 1). The search mechanism enables an analyst user to search for existing super topic taxonomies corresponding to existing concept studies using a text query.

The super topic creation interface 300 can include one or more explicit concept fields (e.g., a concept field 314A and a concept field 314B, collectively as the “explicit concept fields 314”). The explicit concept fields 314 enable an analyst user to specify one or more explicit concept identifiers therein. In this example, the explicit concept fields 314 include multiple input windows for each type of explicit concept identifiers. For example, the concept field 314A can receive explicit concept identifiers in the form of numeric or alphanumeric identifiers corresponding to one or more social network objects (e.g., social network pages or hashtags). A social network page can correspond to a topic tag that is explicitly mentioned by a user or inferred via a topic tagger or an image tagger. The explicit concept identifiers can include text strings (e.g., a term object comprising two or more consecutive words). In another example, the concept field 314B can receive explicit concept identifiers in the form of hashtags.

Each concept field can correspond to a concept type (e.g., a topic tag, a hashtag, or a term object). In some embodiments, at least one of the explicit concept fields 314 implements a typeahead mechanism. The typeahead mechanism matches or attempts to match characters typed into one of the explicit concept fields 314 to the name or description of existing social network objects in a social graph of a social networking system (e.g., the social networking system 902 of FIG. 9).

In some cases, a concept identifier may not correspond to an existing social network object. For example, while a topic tag and/or a hashtag may correspond to a social network object, a term object may not correspond to a social network object. Thus, the typeahead mechanism may be restricted to concept identifiers that correspond to existing social network objects. In some embodiments, the typeahead mechanism matches the characters typed into the explicit concept fields 314 to existing term objects used in other super topic taxonomies.

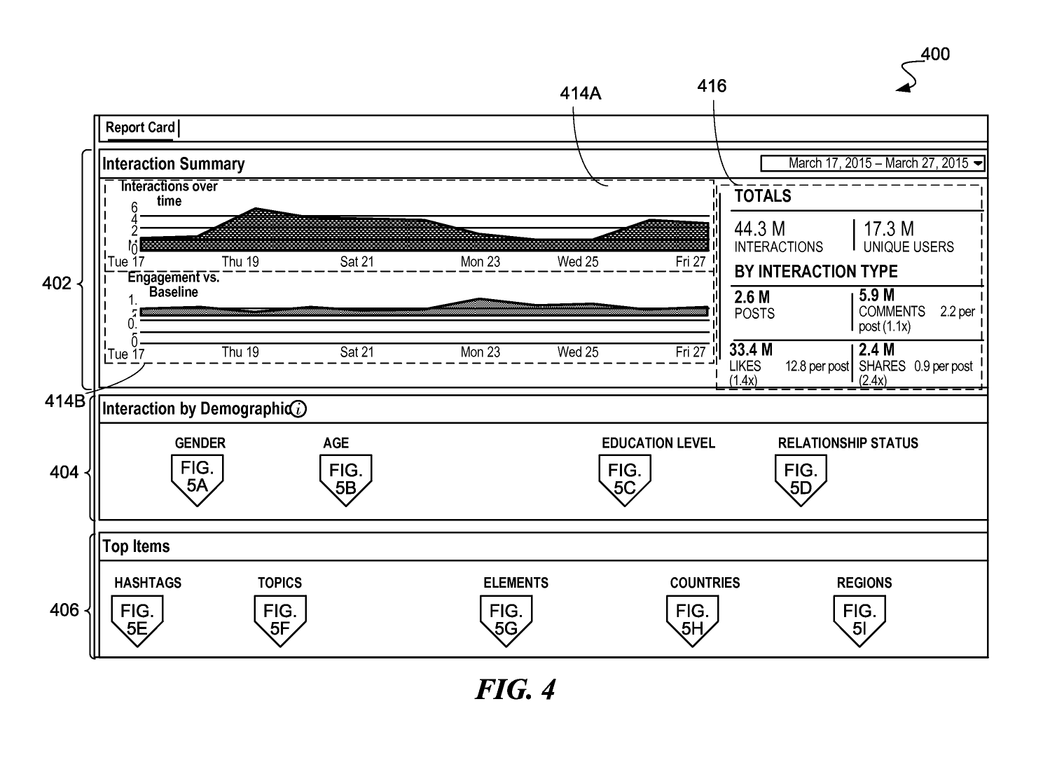

FIG. 4 is an example illustration of a chatter insight interface 400, in accordance with various embodiments. The chatter insight interface 400 can present and display insights produce from a content analysis engine (e.g., the content analysis engine 132 of FIG. 1). For example, the chatter insight interface 400 can include an interaction summary panel 402, an audience segmentation panel 404, and a top items panel 406. The example illustration shows the chatter insight interface 400 for a particular concept study.

In this example illustration, the interaction summary panel 402 includes a time window indicator 412, a visualization 414A, a visualization 414B, and a summary table 416. The time window indicator 412 can specify a begin time (e.g., a begin date) and an end time (e.g., an end date) during which time the input content for the particular concept study is sourced. The begin time and the end time can be the begin time 306 and the end time 308 of FIG. 3. The visualization 414A is a graph of a total number of “interactions” (e.g., user activities) collected by a chatter tracker engine (e.g., the chatter tracker engine 200 of FIG. 2) for the particular concept study over the time window specify by the time window indicator 412. For example, the interactions can be content engagement activities, content generation activities, or both. The visualization 414B is a graph of ratios of content engagement activities relative to a baseline over the time window.

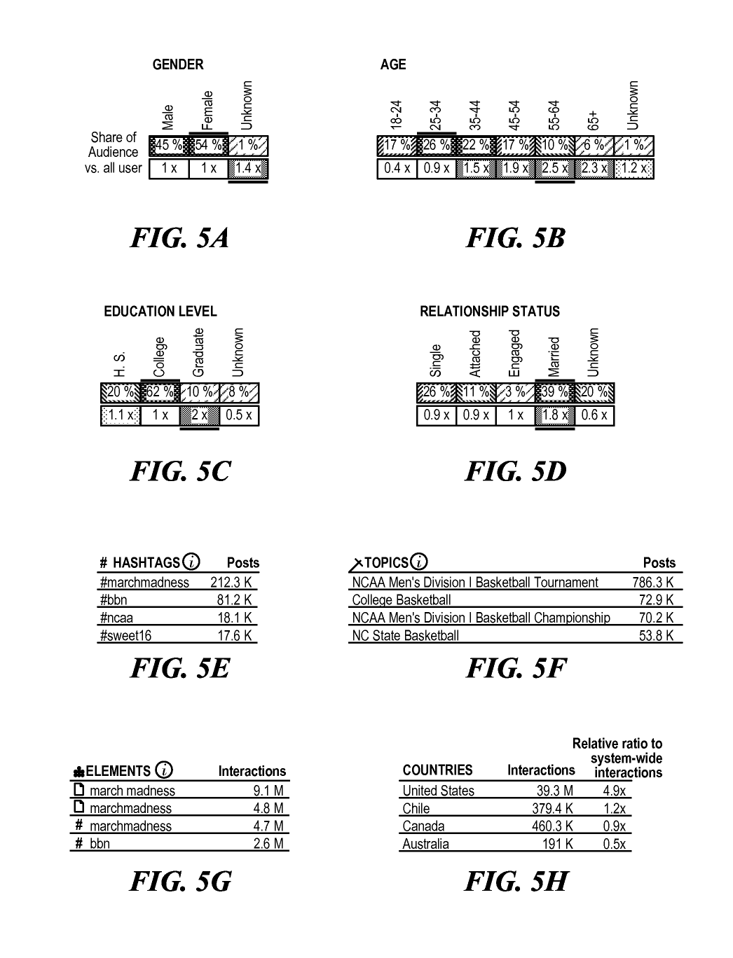

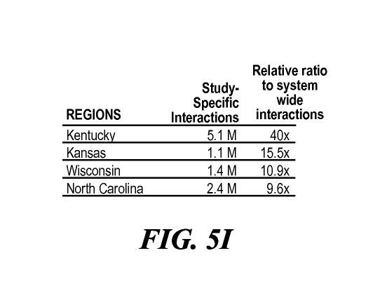

The audience segmentation panel 404 presents and/or displays demographic information regarding the users associated with the user activity collected during the time window by the chatter tracker engine. FIG. 5A is an example illustration of a gender demographic table in the audience segmentation panel 404 of the chatter insight interface 400 of FIG. 4, in accordance with various embodiments. In this example, the gender demographic table lists gender distribution values that compare the share of the audience segmentation that are male or female. The gender demographic table can also display the ratio between the gender distribution values with gender distribution values for all users in a social networking system (e.g., the application service system 100 of FIG. 1 or the social networking system 902 of FIG. 9) that are male or female.

FIG. 5B is an example illustration of an age demographic table in the audience segmentation panel 404 of the chatter insight interface 400 of FIG. 4, in accordance with various embodiments. In this example, the gender demographic table lists age group distribution values that compare the share of the audience segmentation that are within certain age groups. The age demographic table can also display the ratio between the age group distribution values with age group distribution values for all users in the social networking system. FIG. 5C is an example illustration of an education level demographic table in the audience segmentation panel 404 of the chatter insight interface 400 of FIG. 4, in accordance with various embodiments. In this example, the education level demographic table lists education level distribution values that compare the share of the audience segmentation that are within certain education levels. The education level demographic table can also display the ratio between the education level distribution values for the audience segmentation with education level distribution values for all users in the social networking system. FIG. 5D is an example illustration of a relationship status demographic table in the audience segmentation panel 404 of the chatter insight interface 400 of FIG. 4, in accordance with various embodiments. In this example, the relationship status demographic table lists relationship status distribution values that compare the share of the audience segmentation that are within certain relationship status groups. The relationship status demographic table can also display the ratio between the relationship status distribution values of the audience segmentation with relationship status distribution values for all users in the social networking system.

The top items panel 406 presents and/or displays statistical profiles for top categories of user activity collected during the time window by the chatter tracker engine. FIG. 5E is an example illustration of a hashtag list in the top items panel 406 of the chatter insight interface 400 of FIG. 4, in accordance with various embodiments. The hashtag list can include top concept identifiers that are hashtags. For each concept identifier in the hashtag list, the hashtag list can also list a total count of content objects that have been identified by the chatter tracker engine as being associated with the respective concept identifier during the time window. FIG. 5F is an example illustration of a topic list in the top items panel 406 of the chatter insight interface 400 of FIG. 4, in accordance with various embodiments. The topic list can include top concept identifiers that are topic tags. For each concept identifier in the topic list, the topic list also lists a total count of content objects that have been identified by the chatter tracker engine as being associated with the respective concept identifier during the time window. FIG. 5G is an example illustration of an element list in the top items panel 406 of the chatter insight interface 400 of FIG. 4, in accordance with various embodiments. The element list can include top concept identifiers. For each concept identifier in the element list, the element list can also list a total count of content objects that have been identified by the chatter tracker engine as being associated with the respective concept identifier during the time window.

FIG. 5H is an example illustration of a country list in a top items panel of the chatter insight interface 400 of FIG. 4, in accordance with various embodiments. The country list can include a list of countries and respective counts of user activities that have been categorized as pertaining to the particular concept study. The country list can also include the respective ratio of the increase or decrease in shares of user activities in each of the country relative to the social networking system. FIG. 5I is an example illustration of a region list in a top items panel of the chatter insight interface 400 of FIG. 4, in accordance with various embodiments. The region list can include a list of regions and respective counts of user activities that have been categorized as pertaining to the particular concept study. This example shows that, in United States, the user activities pertaining to the particular concept study has 4.9 times the amount as user activities across the social networking system. The region list can also include the respective ratio of the increase or decrease in shares of user activities in each of the country relative to the social networking system.

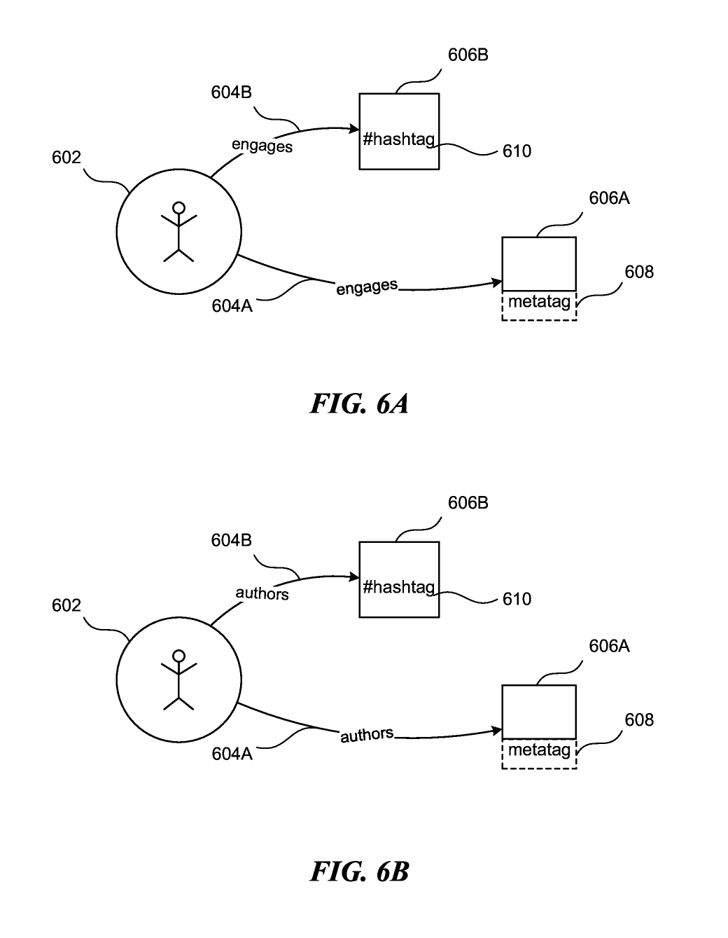

FIG. 6A is an example illustration of a content engagement activity that qualifies as being relevant to a content analysis study according to a super topic taxonomy, in accordance with various embodiments. The content engagement activity describes an acting user 602 engaging with a content object. The content engagement activity can be a “like,” or other form of approval indication or association to the content object. The content engagement activity can be a comment made in association with the content object (the content object not being the comment itself). The content engagement activity can be a visit to the content object.

In this example illustration, a content engagement activity 604A records the acting user 602's engagement with a content object 606A (e.g., a user post or a status update). The content object 606A can include a metadata tag 608. In one example, a topic tagger engine can analyze text strings within the content object 606A to produce a reference to the metadata tag 608. In an example, the topic tagger engine can analyze text strings mentioning football games and assign a metadata tag of a social network page for “American football” to the content object 606A. In another example, an image tagger engine can analyze any photos or images within the content object 606A to produce a reference to the metadata tag 608. In an example, the image tagger engine can analyze a picture of a cat in the content object 606A and assign a metadata tag of a social network page for “cats” to the content object 606A. In other cases, the metadata tag 608 can be created by the acting user 602 explicitly mentioning a social network page in text strings within the content object 606A. A content engagement activity 604B records the acting user 602's engagement with a content object 606B. The content object 606B can include a hashtag 610.

FIG. 6B is an example illustration of a content generation user activity (e.g., posts, creates, status updates) that qualifies as being relevant to a content analysis study according to a super topic taxonomy, in accordance with various embodiments. The content generation activity describes an acting user 622 authoring a content object. For example, the content generation activity can be a user post, a status update, a new page, or a comment. Unlike a content engagement activity involving a comment, a content generation activity is associated with a content object representing the comment itself and not another content object that the comment is associated with.

In this example illustration, a content generation activity 624A records the acting user 602's authorship of a content object 626A. The content object 626A can include a metadata tag 628 similar to the metadata tag 608 of FIG. 6A. In this example illustration, a content generation activity 624B records the acting user 602's authorship of a content object 626B. The content object 626B can include a hashtag 630 similar to the hashtag 610 of FIG. 6A.

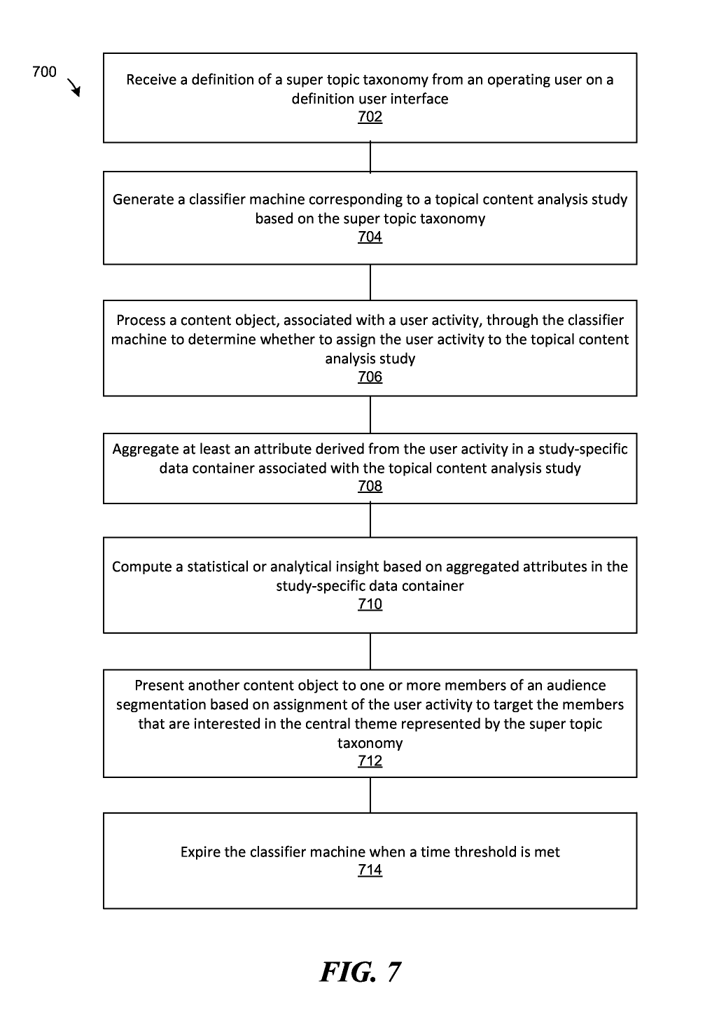

FIG. 7 is a flow chart illustrating a method 700 of operating a concept study system (e.g., the concept study system 112 of FIG. 1), in accordance with various embodiments. The concept study system can be part of a social networking system (e.g., the application service system 100 of FIG. 1 or the social networking system 902 of FIG. 9). At step 702, the concept study system can receive a definition of a super topic taxonomy from an operating user on a definition user interface. The definition of the super topic taxonomy can initiate a topical content analysis study. The super topic taxonomy can include one or more concept identifiers. For example, the super topic taxonomy includes a hashtag, a topic tag, a term object comprising two or more consecutive words, or any combination thereof. The concept identifiers, individually or in any combination, can indicate to the concept study system that a content object relates to a central theme that is of interest to the topical content analysis study.

At step 704, the concept study system can generate a classifier machine corresponding to the topical content analysis study based on the super topic taxonomy. The classifier machines can include finite automatons (e.g., deterministic or non-deterministic), finite state machines, tree automatons, Boolean machines, pattern/string matching algorithms (e.g., Aho-Corosick matching), regular expression string matching, contrast motif finders (CMF), decision trees/tries, random forest classifier models, Bayesian classifier models, ensemble classifier models, other classifier models, or any combination thereof. The generation of the classifier machine can include formation of a Boolean expression, a regular expression, a decision tree/trie, a dictionary, or any combination thereof. In some embodiments, generation of the classifier model includes training the classifier model utilizing supervised or unsupervised learning and labeled content.

At step 706, the concept study system can process a content object, associated with a user activity in a social networking system, through the classifier machine to determine whether to assign the user activity to the topical content analysis study. In some embodiments, processing the content object is in response to the social networking system receiving the user activity from a user device. In some embodiments, processing the content object is asynchronous from the social networking system receiving the user activity.

At step 708, the concept study system can aggregate at least an attribute derived from the user activity in a study-specific data container associated with the topical content analysis study. For example, the concept study system can aggregate at least a user identifier derived from the user activity in an audience segmentation associated with the topical content analysis study.

Aggregating at least the attribute can include increasing a tally. For example, the concept study system can increase a concept object tally that measures how many content objects that have or are associated with a concept identifier in the super topic taxonomy. In another example, the concept study system can increase a concept type tally of one or more content objects that have or are associated with a concept identifier of a particular concept identifier type.

At step 710, the concept study system can compute a statistical or analytical insight based on aggregated attributes in the study-specific data container. For example, the concept study system can compute a statistical or analytical insight based on demographic profile of the audience segmentation. In an example, the statistical or analytical insight can be computed based on demographic information of user identifiers in the audience segmentation. The demographic information can include gender, age, education level, relationship status, or any combination thereof.

In some embodiments, the concept study system can compute the statistical or analytical insight by comparing a statistical measure of the aggregated attributes in the study-specific data container against a baseline statistical measure of a superset of attributes. In some embodiments, the concept study system can normalize the statistical measure against a baseline statistical measure or calculate a ratio between the statistical measure of the study-specific data container and the baseline statistical measure. In one example, when the aggregated attributes are associated with an audience segmentation of acting users, the superset of attributes can correspond to all users in the social networking system or the application service system. In another example, when the aggregated attributes are associated with user-generated content objects, the superset of attributes can correspond to all user-generated content objects in the social networking system or the application service system.

In some embodiments, the concept study system computes the statistical or analytical insight in response to processing the content object. For example, the concept study system can update the statistical or analytical insight on a user interface (e.g., chatter insight interface 400 of FIG. 4) in real-time or substantially real-time based on inclusion of the attribute derived from the user activity in the study-specific data container.

At step 712, the concept study system can presenting another content object to one or more members of the audience segmentation to target the members that are interested in the central theme represented by the super topic taxonomy. At step 714, the concept study system can expire the classifier machine when a time threshold is met. For example, the time threshold can be defined by the end time 308 of FIG. 3.

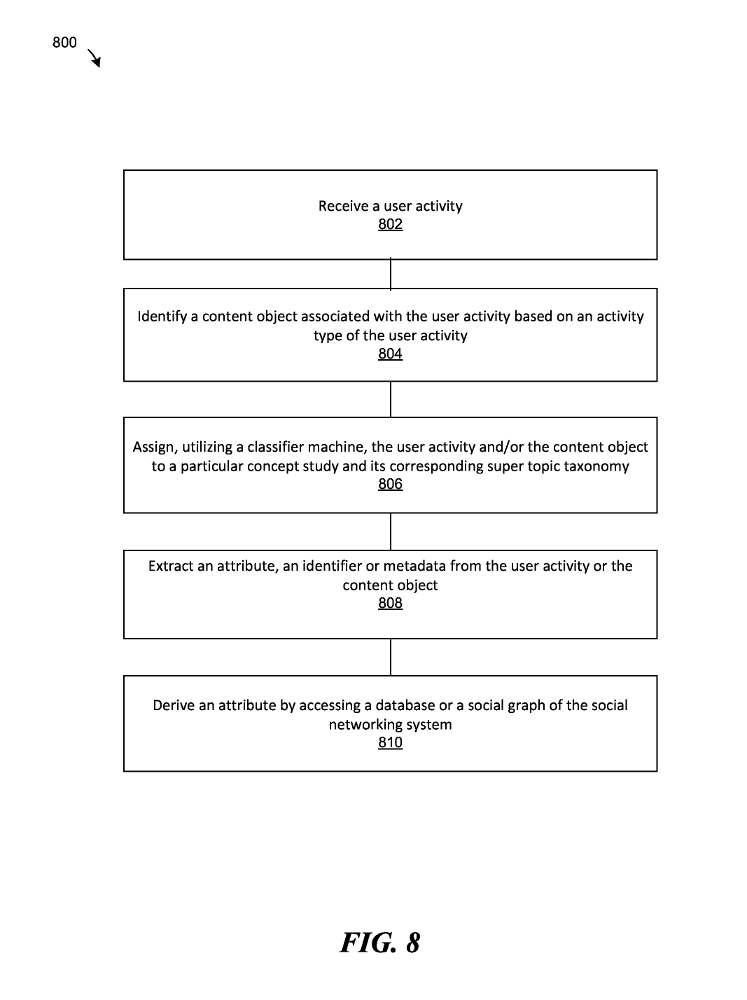

FIG. 8 is a flow chart illustrating a method 800 of operating a chatter tracker engine (e.g., the tracker engine 124 of FIG. 1 or the chatter tracker engine 200 of FIG. 2), in accordance with various embodiments. The method 800 can correspond to step 706 of FIG. 7. At step 802, the chatter tracker engine can receive a user activity. For example, the chatter tracker engine can receive the user activity from a social network interface. In some embodiments, a social networking system (e.g., an application service system 100 of FIG. 1 or the social networking system 902 of FIG. 9) delivers the user activity to the chatter tracker engine in response to receiving the user activity from a user device.

At step 804, the chatter tracker engine can identify a content object associated with the user activity based on an activity type of the user activity. For example, the chatter tracker engine can determine that the user activity corresponds to a content engagement activity (e.g., a like, a comment, a share, a visit, or any combination thereof) to engage the content object. For another example, the chatter tracker engine can determine that the user activity corresponds to a content generation activity that produces the content object.

At step 806, the chatter tracker engine can assign the user activity and/or the content object to a particular concept study and its corresponding super topic taxonomy. For example, the chatter tracker engine can utilize a classifier machine (e.g., generated in step 704) to perform the assignment. The chatter tracker engine can provide the content object to the classifier machine as input. In one example, the classifier machine can determine that a concept identifier in the super topic taxonomy of the particular concept study is in or associated with the content object. The classifier machine can then assign the content object and the user activity to the particular concept study accordingly.

At step 808, the chatter tracker engine can extract a value (e.g., an attribute, an identifier or metadata) from the user activity or the content object. In one example, the identifier is a user identifier of an acting user of the user activity. In one example, the metadata is geolocation information. For example, the geolocation information is associated with where the user activity is initiated

In some embodiments, an attribute is a derivative of the extracted value. The attribute can be calculated utilizing additional data from the social networking system or an external system. For example, at step 810, the chatter tracker engine can derive an attribute by accessing a database or a social graph of the social networking system. For example, the chatter tracker engine can derive a user demographic as the attribute for aggregation by accessing a user profile corresponding to the user identifier from the social networking system.

While processes or blocks are presented in a given order in this disclosure, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

FIG. 9 is a high-level block diagram of a system environment 900 suitable for a social networking system 902, in accordance with various embodiments. The system environment 900 shown in FIG. 9 includes the social networking system 902 (e.g., the application service system 100 of FIG. 1), a client device 904A, and a network channel 906. The system environment 900 can include other client devices as well, e.g., a client device 904B and a client device 904C. In other embodiments, the system environment 900 may include different and/or additional components than those shown by FIG. 9. The chatter tracker engine 200 of FIG. 2 can be implemented in the social networking system 902.

### Social Networking System Environment and Architecture

The social networking system 902, further described below, comprises one or more computing devices storing user profiles associated with users (i.e., social networking accounts) and/or other objects as well as connections between users and other users and/or objects. Users join the social networking system 902 and then add connections to other users or objects of the social networking system to which they desire to be connected. Users of the social networking system 902 may be individuals or entities, e.g., businesses, organizations, universities, manufacturers, etc. The social networking system 902 enables its users to interact with each other as well as with other objects maintained by the social networking system 902. In some embodiments, the social networking system 902 enables users to interact with third-party websites and a financial account provider.

Based on stored data about users, objects and connections between users and/or objects, the social networking system 902 generates and maintains a “social graph” comprising multiple nodes interconnected by multiple edges. Each node in the social graph represents an object or user that can act on another node and/or that can be acted on by another node. An edge between two nodes in the social graph represents a particular kind of connection between the two nodes, which may result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system 902 adds and/or modifies edges connecting the various nodes to reflect the interactions.

The client device 904A is a computing device capable of receiving user input as well as transmitting and/or receiving data via the network channel 906. In at least one embodiment, the client device 904A is a conventional computer system, e.g., a desktop or laptop computer. In another embodiment, the client device 904A may be a device having computer functionality, e.g., a personal digital assistant (PDA), mobile telephone, a tablet, a smart-phone or similar device. In yet another embodiment, the client device 904A can be a virtualized desktop running on a cloud computing service. The client device 904A is configured to communicate with the social networking system 902 via a network channel 906 (e.g., an intranet or the Internet). In at least one embodiment, the client device 904A executes an application enabling a user of the client device 904A to interact with the social networking system 902. For example, the client device 904A executes a browser application to enable interaction between the client device 904A and the social networking system 902 via the network channel 906. In another embodiment, the client device 904A interacts with the social networking system 902 through an application programming interface (API) that runs on the native operating system of the client device 904A, e.g., IOS® or ANDROID™

The client device 904A is configured to communicate via the network channel 906, which may comprise any combination of local area and/or wide area networks, using both wired and wireless communication systems. In at least one embodiment, the network channel 906 uses standard communications technologies and/or protocols. Thus, the network channel 906 may include links using technologies, e.g., Ethernet, 802.11, worldwide interoperability for microwave access (WiMAX), 3G, 4G, CDMA, digital subscriber line (DSL), etc. Similarly, the networking protocols used on the network channel 906 may include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network channel 906 may be represented using technologies and/or formats including hypertext markup language (HTML) or extensible markup language (XML). In addition, all or some of links can be encrypted using conventional encryption technologies, e.g., secure sockets layer (SSL), transport layer security (TLS), and Internet Protocol security (IPsec).

The social networking system 902 includes a profile store 910, a content store 912, an action logger 914, an action log 916, an edge store 918, a web server 924, a message server 926, an application service interface (API) request server 928, a concept study system 932, a topic tagger engine 934, an image tagger engine 936, or any combination thereof. In other embodiments, the social networking system 902 may include additional, fewer, or different modules for various applications.

User of the social networking system 902 can be associated with a user profile, which is stored in the profile store 910. The user profile is associated with a social networking account. A user profile includes declarative information about the user that was explicitly shared by the user, and may include profile information inferred by the social networking system 902. In some embodiments, a user profile includes multiple data fields, each data field describing one or more attributes of the corresponding user of the social networking system 902. The user profile information stored in the profile store 910 describes the users of the social networking system 902, including biographic, demographic, and other types of descriptive information, e.g., work experience, educational history, gender, hobbies or preferences, location and the like. A user profile may also store other information provided by the user, for example, images or videos. In some embodiments, images of users may be tagged with identification information of users of the social networking system 902 displayed in an image. A user profile in the profile store 910 may also maintain references to actions by the corresponding user performed on content items (e.g., items in the content store 912) and stored in the edge store 918 or the action log 916.

A user profile may be associated with one or more financial accounts, enabling the user profile to include data retrieved from or derived from a financial account. In some embodiments, information from the financial account is stored in the profile store 910. In other embodiments, it may be stored in an external store.

A user may specify one or more privacy settings, which are stored in the user profile, that limit information shared through the social networking system 902. For example, a privacy setting limits access to cache appliances associated with users of the social networking system 902.

The content store 912 stores content items (e.g., images, videos, or audio files) associated with a user profile. The content store 912 can also store references to content items that are stored in an external storage or external system. Content items from the content store 912 may be displayed when a user profile is viewed or when other content associated with the user profile is viewed. For example, displayed content items may show images or video associated with a user profile or show text describing a user's status. Additionally, other content items may facilitate user engagement by encouraging a user to expand his connections to other users, to invite new users to the system or to increase interaction with the social networking system by displaying content related to users, objects, activities, or functionalities of the social networking system 902. Examples of social networking content items include suggested connections or suggestions to perform other actions, media provided to, or maintained by, the social networking system 902 (e.g., pictures or videos), status messages or links posted by users to the social networking system, events, groups, pages (e.g., representing an organization or commercial entity), and any other content provided by, or accessible via, the social networking system.

The content store 912 also includes one or more pages associated with entities having user profiles in the profile store 910. An entity can be a non-individual user of the social networking system 902, e.g., a business, a vendor, an organization, or a university. A page includes content associated with an entity and instructions for presenting the content to a social networking system user. For example, a page identifies content associated with the entity's user profile as well as information describing how to present the content to users viewing the brand page. Vendors may be associated with pages in the content store 912, enabling social networking system users to more easily interact with the vendor via the social networking system 902. A vendor identifier is associated with a vendor's page, thereby enabling the social networking system 902 to identify the vendor and/or to retrieve additional information about the vendor from the profile store 910, the action log 916 or from any other suitable source using the vendor identifier. In some embodiments, the content store 912 may also store one or more targeting criteria associated with stored objects and identifying one or more characteristics of a user to which the object is eligible to be presented.

The action logger 914 receives communications about user actions on and/or off the social networking system 902, populating the action log 916 with information about user actions. Such actions may include, for example, adding a connection to another user, sending a message to another user, uploading an image, reading a message from another user, viewing content associated with another user, attending an event posted by another user, among others. In some embodiments, the action logger 914 receives, subject to one or more privacy settings, content interaction activities associated with a user. In addition, a number of actions described in connection with other objects are directed at particular users, so these actions are associated with those users as well. These actions are stored in the action log 916.

In accordance with various embodiments, the action logger 914 is capable of receiving communications from the web server 924 about user actions on and/or off the social networking system 902. The action logger 914 populates the action log 916 with information about user actions to track them. This information may be subject to privacy settings associated with the user. Any action that a particular user takes with respect to another user is associated with each user's profile, through information maintained in a database or other data repository, e.g., the action log 916. Such actions may include, for example, adding a connection to the other user, sending a message to the other user, reading a message from the other user, viewing content associated with the other user, attending an event posted by another user, being tagged in photos with another user, liking an entity, etc.

The action log 916 may be used by the social networking system 902 to track user actions on the social networking system 902, as well as external website that communicate information to the social networking system 902. Users may interact with various objects on the social networking system 902, including commenting on posts, sharing links, and checking-in to physical locations via a mobile device, accessing content items in a sequence or other interactions. Information describing these actions is stored in the action log 916. Additional examples of interactions with objects on the social networking system 902 included in the action log 916 include commenting on a photo album, communications between users, becoming a fan of a musician, adding an event to a calendar, joining a groups, becoming a fan of a brand page, creating an event, authorizing an application, using an application and engaging in a transaction. Additionally, the action log 916 records a user's interactions with advertisements on the social networking system 902 as well as applications operating on the social networking system 902. In some embodiments, data from the action log 916 is used to infer interests or preferences of the user, augmenting the interests included in the user profile, and enabling a more complete understanding of user preferences.

Further, user actions that happened in particular context, e.g., when the user was shown or was seen accessing particular content on the social networking system 902, can be captured along with the particular context and logged. For example, a particular user could be shown/not-shown information regarding candidate users every time the particular user accessed the social networking system 902 for a fixed period of time. Any actions taken by the user during this period of time are logged along with the context information (i.e., candidate users were provided/not provided to the particular user) and are recorded in the action log 916. In addition, a number of actions described below in connection with other objects are directed at particular users, so these actions are associated with those users as well.

The action log 916 may also store user actions taken on external websites services associated with the user. The action log 916 records data about these users, including viewing histories, advertisements that were engaged, purchases or rentals made, and other patterns from content requests and/or content interactions.

In some embodiments, the edge store 918 stores the information describing connections between users and other objects on the social networking system 902 in edge objects. The edge store 918 can store the social graph described above. Some edges may be defined by users, enabling users to specify their relationships with other users. For example, users may generate edges with other users that parallel the users' real-life relationships, e.g., friends, co-workers, partners, and so forth. Other edges are generated when users interact with objects in the social networking system 902, e.g., expressing interest in a page or a content item on the social networking system, sharing a link with other users of the social networking system, and commenting on posts made by other users of the social networking system. The edge store 918 stores edge objects that include information about the edge, e.g., affinity scores for objects, interests, and other users. Affinity scores may be computed by the social networking system 902 over time to approximate a user's affinity for an object, interest, and other users in the social networking system 902 based on the actions performed by the user. Multiple interactions of the same type between a user and a specific object may be stored in one edge object in the edge store 918, in at least one embodiment. In some embodiments, connections between users may be stored in the profile store 910. In some embodiments, the profile store 910 may reference or be referenced by the edge store 918 to determine connections between users. Users may select from predefined types of connections, or define their own connection types as needed.

The web server 924 links the social networking system 902 via a network to one or more client devices; the web server 924 serves web pages, as well as other web-related content, e.g., Java, Flash, XML, and so forth. The web server 924 may communicate with the message server 926 that provides the functionality of receiving and routing messages between the social networking system 902 and client devices. The messages processed by the message server 926 can be instant messages, email messages, text and SMS (short message service) messages, photos, or any other suitable messaging technique. In some embodiments, a message sent by a user to another user can be viewed by other users of the social networking system 902, for example, by the connections of the user receiving the message. An example of a type of message that can be viewed by other users of the social networking system besides the recipient of the message is a wall post. In some embodiments, a user can send a private message to another user that can only be retrieved by the other user.

The API request server 928 enables external systems to access information from the social networking system 902 by calling APIs. The information provided by the social network may include user profile information or the connection information of users as determined by their individual privacy settings. For example, a system interested in predicting the probability of users forming a connection within a social networking system may send an API request to the social networking system 902 via a network. The API request server 928 of the social networking system 902 receives the API request. The API request server 928 processes the request by determining the appropriate response, which is then communicated back to the requesting system via a network.

The concept study system 932 can be the concept study system 112 of FIG. 1. The concept study system 932 can enable analyst users to define, modify, track, execute, compare, analyze, evaluate, and/or deploy one or more concept studies associated with one or more super topic taxonomies. A chatter tracker engine of the concept study system 932 can classify user activities (e.g., tracked by the action logger 914) in the social networking system 902. The chatter tracker engine can aggregate user activities and attributes relating to the user activities. The concept study system 932 can then analyze the aggregate activities to produce statistical or analytical insights based on machine intelligence.

The topic tagger engine 934 can analyze text strings within the content objects in the content store 912 to produce a reference to a social network page. The image tagger engine 936 can analyze multimedia objects within the content objects in the content store 912 to produce a reference to a social network page. The concept study system 932 can make use of the references (e.g., topic tags) produced from the topic tagger engine 934 or the image tagger engine 936 to classify user activities for concept studies.

Functional components (e.g., circuits, devices, engines, modules, and data storages, etc.) associated with the application service system 100 of FIG. 1, the chatter tracker engine 200 of FIG. 2, and/or the social networking system 902 of FIG. 9, can be implemented as a combination of circuitry, firmware, software, or other functional instructions. For example, the functional components can be implemented in the form of special-purpose circuitry, in the form of one or more appropriately programmed processors, a single board chip, a field programmable gate array, a network-capable computing device, a virtual machine, a cloud computing environment, or any combination thereof. For example, the functional components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method step or method steps of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implements a portion of the functional components). The systems, engines, or devices described may include additional, fewer, or different functional components for various applications.

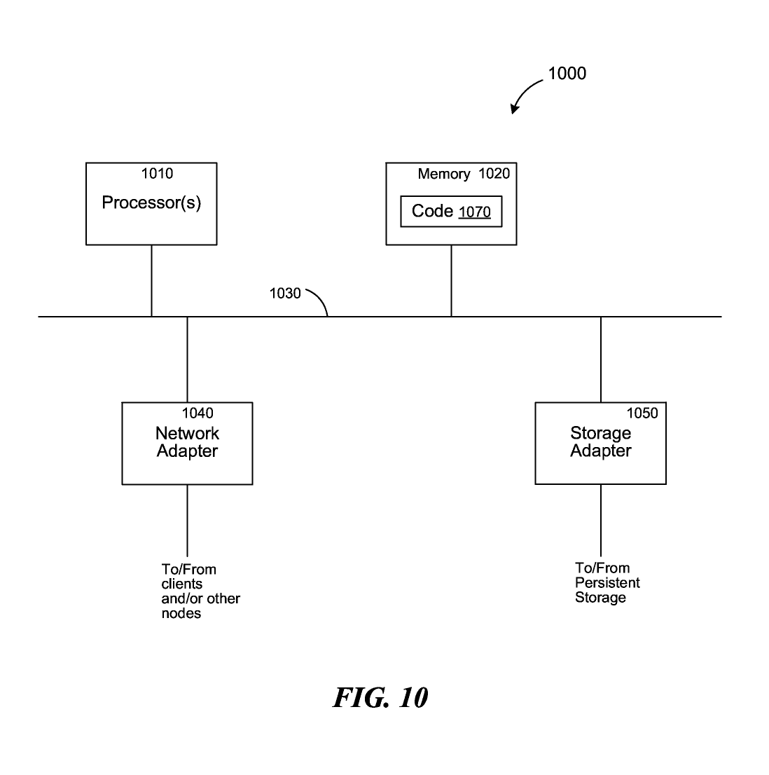

FIG. 10 is a block diagram of an example of a computing device 1000, which may represent one or more computing device or server described herein, in accordance with various embodiments. The computing device 1000 can be one or more computing devices that implement the application service system 100 of FIG. 1 and/or the chatter tracker engine 200 of FIG. 2. The computing device 1000 can execute at least part of the method 700 of FIG. 7 and/or the method 800 of FIG. 8. The computing device 1000 includes one or more processors 1010 and memory 1020 coupled to an interconnect 1030. The interconnect 1030 shown in FIG. 10 is an abstraction that represents any one or more separate physical buses, point-to-point connections, or both connected by appropriate bridges, adapters, or controllers. The interconnect 1030, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 1010 is/are the central processing unit (CPU) of the computing device 1000 and thus controls the overall operation of the computing device 1000. In certain embodiments, the processor(s) 1010 accomplishes this by executing software or firmware stored in memory 1020. The processor(s) 1010 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 1020 is or includes the main memory of the computing device 1000. The memory 1020 represents any form of random access memory (RAM), read-only memory (ROM), flash memory, or the like, or a combination of such devices. In use, the memory 1020 may contain a code 1070 containing instructions according to the mesh connection system disclosed herein.

Also connected to the processor(s) 1010 through the interconnect 1030 are a network adapter 1040 and a storage adapter 1050. The network adapter 1040 provides the computing device 1000 with the ability to communicate with remote devices, over a network and may be, for example, an Ethernet adapter or Fibre Channel adapter. The network adapter 1040 may also provide the computing device 1000 with the ability to communicate with other computers. The storage adapter 1050 enables the computing device 1000 to access a persistent storage, and may be, for example, a Fibre Channel adapter or SCSI adapter.

The code 1070 stored in memory 1020 may be implemented as software and/or firmware to program the processor(s) 1010 to carry out actions described above. In certain embodiments, such software or firmware may be initially provided to the computing device 1000 by downloading it from a remote system through the computing device 1000 (e.g., via network adapter 1040).

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; and/or optical storage media; flash memory devices), etc.

The term “logic,” as used herein, can include, for example, programmable circuitry programmed with specific software and/or firmware, special-purpose hardwired circuitry, or a combination thereof.

Some embodiments of the disclosure have other aspects, elements, features, and steps in addition to or in place of what is described above. These potential additions and replacements are described throughout the rest of the specification. Reference in this specification to “various embodiments” or “some embodiments” means that a particular feature, structure, or characteristic described in connection with the embodiment is included in at least one embodiment of the disclosure. Alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments. Reference in this specification to where a result of an action is “based on” another element or feature means that the result produced by the action can change depending at least on the nature of the other element or feature.

Some embodiments include a social networking system. The social networking system can include a classifier machine repository storing one or more active classifier machines; a machine generator engine configured to generate a classifier machine corresponding to a topical content analysis study based on a super topic taxonomy having one or more concept identifiers and to store the classifier machine in the classifier machine repository; a study-specific data aggregation container associated with the topical content analysis study; and an activity processor configured to implement a machines aggregate combining the active classifier machines in the classifier machine repository to process a content object associated with a user activity and to aggregate at least an attribute of the content object or the user activity in the study-specific data container. In some embodiments, the machines aggregate can process the content object in real-time in response to the social networking system receiving the user activity.

What is claimed is:

1. A computer-implemented method, comprising:
generating a finite automaton machine corresponding to a topical content analysis study based on a super topic taxonomy including one or more concept identifiers;
processing a content object, associated with a user activity in a social networking system, through the finite automaton machine to determine whether to assign the user activity to the topical content analysis study;
aggregating at least an attribute derived from the user activity in a study-specific data container associated with the topical content analysis study; and
computing a statistical or analytical insight based on aggregated attributes in the study-specific data container, wherein the statistical or analytical insight includes a computer-rendered illustration or a computational measurement from processing the aggregated attributes.

2. The computer-implemented method of claim 1, wherein the super topic taxonomy includes a hashtag, a topic tag, a term object comprising two or more consecutive words, or any combination thereof.

3. The computer-implemented method of claim 1, wherein processing the content object is in response to the social networking system receiving the user activity from a user device.

4. The computer-implemented method of claim 1, wherein processing the content object is asynchronous from the social networking system receiving the user activity.

5. The computer-implemented method of claim 1, wherein computing the statistical or analytical insight is in response to processing the content object; and wherein computing the statistical or analytical insight includes updating the statistical or analytical insight on a user interface in real-time or substantially real-time based on inclusion of the attribute derived from the user activity in the study-specific data container.

6. The computer-implemented method of claim 1, further comprising:
extracting a user identifier from the user activity; and
deriving a user demographic as the attribute for aggregation by accessing a user profile corresponding to the user identifier from the social networking system.

7. The computer-implemented method of claim 1, wherein the attribute is a user identifier of an acting user of the user activity; and wherein the study-specific data container is an audience segmentation corresponding to the topical content analysis study.

8. The computer-implemented method of claim 7, wherein computing the statistical or analytical insight is based on demographic information of user identifiers in the audience segmentation.

9. The computer-implemented method of claim 1, further comprising extracting geolocation information from the user activity as the attribute for aggregation.

10. The computer-implemented method of claim 1, wherein processing the content object includes determining that a concept identifier in the super topic taxonomy is in or associated with the content object; and wherein aggregating at least the attribute includes increasing a tally of one or more content objects that have or are associated with the concept identifier.

11. The computer-implemented method of claim 1, wherein processing the content object includes determining that a concept identifier in the super topic taxonomy of a particular concept identifier type is in or associated with the content object; and wherein aggregating at least the attribute includes increasing a tally of one or more content objects that have or are associated with a concept identifier of the particular concept identifier type.

12. The computer-implemented method of claim 1, wherein processing the content object includes:
determining that the user activity corresponds to a content engagement activity to engage the content object; and
providing the content object as input to the finite automaton machine.

13. The computer-implemented method of claim 1, wherein processing the content object includes:
determining that the user activity corresponds to a content generation activity that produces the content object; and
providing the content object as input to the finite automaton machine.

14. The computer-implemented method of claim 1, wherein computing the statistical or analytical insight is by comparing a statistical measure of the aggregated attributes in the study-specific data container to a baseline statistical measure of a superset of attributes.

15. The computer-implemented method of claim 1, further comprising expiring the finite automaton machine when a time threshold is met.

16. A computer readable data storage memory storing computer-executable instructions that, when executed by a computer system, cause the computer system to perform a computer-implemented method, the instructions comprising:
instructions for generating a classifier machine corresponding to a content analysis study based on a super topic taxonomy associated with a central theme for a topical content analysis study;
instructions for identifying a content object associated with a user activity in a social networking system;
instructions for processing the content object through the classifier machine to determine whether to assign the user activity or the content object to the topical content analysis study;
instructions for aggregating at least a user identifier derived from the user activity in an audience segmentation associated with the topical content analysis study; and
instructions for computing a statistical or analytical insight based on demographic profile of the audience segmentation, wherein the statistical or analytical insight includes a computer-rendered illustration or a computational measurement from processing the aggregated attributes.

17. The computer readable data storage memory of claim 16, wherein the instructions further comprises:
instructions for presenting another content object to one or more members of the audience segmentation to target the members that are interested in a central theme represented by the super topic taxonomy.

18. The computer readable data storage memory of claim 16, wherein the classifier machine includes a Boolean expression, a regular expression, a decision tree/trie, a dictionary, or any combination thereof.

19. The computer readable data storage memory of claim 16, wherein the instructions further comprises:
instructions for training the classifier model utilizing supervised or unsupervised machine learning and labeled content.

20. A social networking system, comprising:
a classifier machine repository storing one or more active classifier machines;
a machine generator engine configured to generate a classifier machine corresponding to a topical content analysis study based on a super topic taxonomy having one or more concept identifiers and to store the classifier machine in the classifier machine repository;
a study-specific data aggregation container associated with the topical content analysis study; and
an activity processor configured to implement a machines aggregate combining the active classifier machines in the classifier machine repository to process a content object associated with a user activity and to aggregate at least an attribute of the content object or the user activity in the study-specific data container.
